(19) United States
(12) Patent Application Publication
(10) Pub. No.: US 2006/0018414 A1
(43) Pub. Date: Jan. 26, 2006

(54) RF receiver using AGC and RF receiving method

(76) Inventors: Vladimir Arkhipenkov, Suwon-si (KR); In-sik Chang, Seoul (KR)

Correspondence Address: STANZIONE & KIM, LLP, 919 18TH STREET, N.W., SUITE 440, WASHINGTON, DC, 20006, US

(21) Appl. No.: 11/159,102

(22) Filed: Jun. 23, 2005

(30) Foreign Application Priority Data
Jul. 26, 2004 (KR) 2004-58406

(51) Int. Cl. H04L 27/08

(52) U.S. Cl. 375/345

(57) ABSTRACT

A radio frequency receiver using an auto gain controller, and a radio frequency receiving method. The radio frequency receiving method includes receiving and attenuating a radio frequency signal including one or more inband signals of at least one channel and an inter-band signal between the inband signals according to a predetermined attenuation degree, amplifying an output signal, and measuring a signal-to-noise ratio of the inband signal of a desired channel of the output signal where the inter-band signal adjacent to the desired channel is a representative of an inband noise and controlling the attenuation degree so that the measured signal-to-noise ratio is maintained higher than a previous signal-to-noise ratio.

### CROSS-REFERENCE TO RELATED APPLICATIONS

This application claims the benefit under 35 U.S.C. §119 of Korean Patent Application No. 2004-58406, filed Jul. 26, 2004, in the Korean Intellectual Property Office, the disclosure of which is incorporated herein by reference.

### BACKGROUND OF THE INVENTION

1. Field of the Invention

The present general inventive concept relates to a radio frequency (RF) receiver and an RF receiving method, and more particularly, to an RF receiver using an auto gain controller (AGC) to increase a signal-to-noise ratio (SNR) of a received signal to optimize a reception of an RF signal, and an RF receiving method thereof.

2. Description of the Related Art

8 vestigial side band (VSB) modulated digital broadcasting signals or other broadcasting signals are signals received according to a modulation method of transmitting a signal to a single carrier. Here, several signals of the 8 VSB modulated digital broadcasting signals or the other signals include a multichannel through which a frequency bandwidth varies. Multichannel signals are adjacent to one another in channels. Thus, noise caused due to intermodulation or the like can be a serious problem.

The ‘intermodulation’ refers to a phenomenon in which a frequency component including a combination of a sum of and a difference between harmonic frequencies of two or more different input frequency signals is output in a process of processing an RF signal including a non-linear device. An intermodulation signal is noise interrupting an original signal and is generally called intermodulation distortion (IMD).

FIG. 1 is a waveform illustrating a frequency spectrum of a digital broadcasting signal using an 8 VSB transmission method.

For example, the digital broadcasting signal shown in FIG. 1 includes only three channels a, b, and c. As shown in FIG. 1, the three channels a, b, and c to be selected are referred to as inbands, and two intervals d and e respectively between two channels a and b and between two channels b and c are referred to as inter-bands.

Intermodulation signals are generated in received neighboring RF signals due to a non-linearity of each device of a receiving system. In the interval e, a dotted line indicates a magnitude of a desired inter-band signal, and a solid line indicates that the magnitude of an inter-band signal is increased by intermodulation. An intermodulation signal does not exist only in an inter-band. Thus, an inband includes noise by the intermodulation signal.

If a power of the signals of neighboring channels is greater than a power of a signal of a desired channel, this problem gets more serious. Therefore, a precise gain control method is required to improve an SNR so as to accurately select only signals of substantially desired channels.

### SUMMARY OF THE INVENTION

In order to solve the foregoing and/or other problems, the present general inventive concept provides an RF receiver using an AGC to attenuate an RF signal depending on a result of measuring an SNR of a received RF signal to improve an SNR, and an RF receiving method thereof.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a radio frequency receiver including an attenuator to receive and attenuate a radio frequency signal including one or more inband signals of at least one channel and an inter-band signal between the inband signals so as to be proportional to a predetermined attenuation degree, an amplifier to amplify a signal output from the attenuator, and a signal-to-noise ratio adjuster measure a signal-to-noise ratio of the inband signal of a desired channel of the signal output from the amplifier and to control the attenuation degree of the attenuator so that the measured signal-to-noise ratio is maintained higher than a previous signal-to-noise ratio.

If the measured signal-to-noise ratio is higher than the previous signal-to-noise ratio, the signal-to-noise ratio adjuster may increase or decrease the attenuation degree of the attenuator in an identical direction to a previous increase or decrease direction.

If the measured signal-to-noise ratio is lower than the previous signal-to-noise ratio, the signal-to-noise ratio adjuster may increase or decrease the attenuation degree of the attenuator in an opposite direction to the previous increase or decrease direction.

If the measured signal-to-noise ratio is higher than the previous signal-to-noise ratio, and the attenuation degree of the attenuator is equal to one of maximum or minimum values, the signal-to-noise ratio adjuster may increase or decrease the attenuation degree of the attenuator in the opposite direction to the previous increase or decrease direction.

The signal-to-noise ratio adjuster may include a first band pass filter to filter an output signal of the amplifier to separate the inband signal of the desired channel of the received signal, a second band pass filter to filter the output signal of the amplifier to separate the inter-band signal of the received signal adjacent to the inband signal of the desired channel, a first auto gain control detector measure a power of the inband signal separated by the first band pass filter, a second auto gain control detector to measure a power of the inter-band signal separated by the second band pass filter, and a solver measure a signal-to-noise ratio of the inband signal using the power measured by the first auto gain control detector as a power of a signal and the power measured by the second auto gain control detector as a power of noise and to control the attenuation degree of the attenuator according to the measured signal-to-noise ratio.

The first and second band pass filters may be surface acoustic wave (SAW) filters.

The radio frequency signal may be a digital television broadcasting signal using an 8 vestigial side band (VSB) method.

The radio frequency receiver may further include a mixer installed between the amplifier and the signal-to-noise ratio adjuster to receive a signal of a predetermined local oscillator so as to transform a frequency of the received digital broadcasting signal into a frequency bandwidth of a channel to be selected, and a radio frequency filter to filter an output signal of the mixer to separate the broadcasting signal having the frequency bandwidth, and to transmit the separated signal to the signal-to-noise ratio adjuster.

The foregoing and/or other aspects and advantages of the present general inventive concept may also be achieved by providing a tuner including a radio frequency receiver to control an attenuation degree of a signal according to a signal-to-noise ratio of an inband signal obtained from a power of the inband signal as a power of a signal and a power of an inter-band signal as a power of noise so as to select a desired broadcasting signal of a digital television broadcasting signal using an 8 vestigial side band method.

The foregoing and/or other aspects and advantages of the present general inventive concept may also be achieved by providing a radio frequency receiving method including receiving and attenuating a radio frequency signal including inband signals of at least one channel and an inter-band signal between the inband signals so as to be proportional to a predetermined attenuation degree amplifying an output signal and measuring a signal-to-noise ratio of an inband signal of a desired channel of the output signal and controlling the attenuation degree so that the measured signal-to-noise ratio is maintained higher than a previous signal-to-noise ratio.

If the measured signal-to-noise ratio is higher than the previous signal-to-noise ratio, the attenuation degree may be increased or decreased in an identical direction to a previous increase or decrease direction.

If the measured signal-to-noise ratio is lower than the previous signal-to-noise ratio, the attenuation degree may be increased or decreased in an opposite direction to the previous increase or decrease direction.

If the measured signal-to-noise ratio is higher than the previous signal-to-noise ratio, and the attenuation degree is equal to one of maximum or minimum values, the attenuation degree may be increased or decreased in the opposite direction to the previous increase or decrease direction.

The controlling of the attenuation degree may include filtering the amplified signal to separate the inband signal of a desired channel of the received signal and measuring a power of the separated inband signal, filtering the amplified signal to separate an inter-band signal of the received signal adjacent to the inband signal of the desired channel, measuring a power of the separated inter-band signal and measuring a signal-to-noise ratio of the inband signal using the power of the inband signal as a power of a signal and the power of the inter-band signal as a power of noise, and controlling the attenuation degree according to the measured signal-to-noise ratio.

The powers of the inband and inter-band signals may be separated using surface acoustic wave filters.

The radio frequency signal may be a digital television broadcasting signal using an 8 vestigial side band method.

The radio frequency receiving method may further include receiving a signal of a predetermined local oscillator so as to transform a frequency of the received digital broadcasting signal into a frequency bandwidth of a channel to be selected, and filtering an output signal except the broadcasting signal and transmitting the filtered signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a waveform illustrating a frequency spectrum of a conventions digital broadcasting signal using an 8 VSB transmission method;

FIG. 2 is a block diagram of an RF receiver using an AGC according to an embodiment of the present general inventive concept;

FIG. 3 is a flowchart illustrating an operation of a solver shown in FIG. 2;

FIG. 4 is a block diagram of an RF receiver using an AGC according to another embodiment of the present general inventive concept; and

FIG. 5 is a flowchart illustrating an operation of an RF receiver using an AGC according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

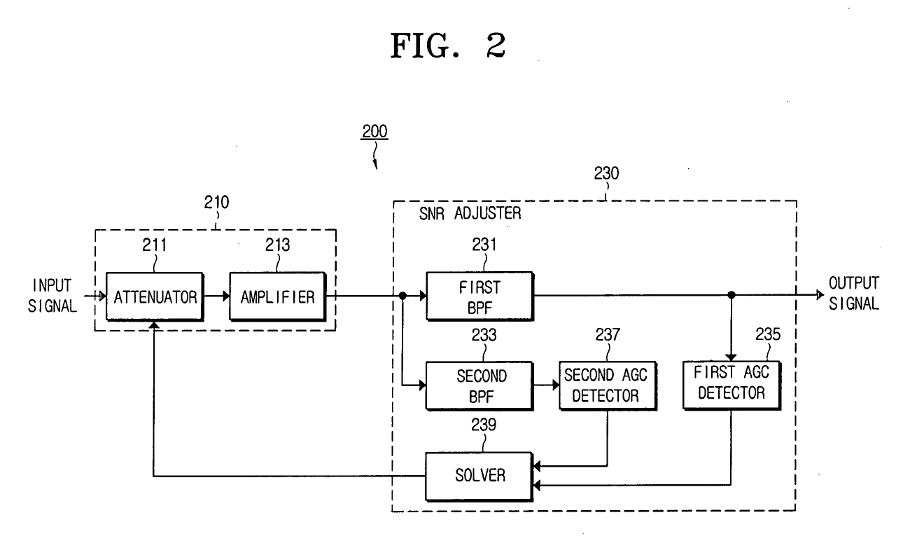

FIG. 2 is a block diagram of an RF receiver 200 using an AGC according to an embodiment of the present general inventive concept.

The RF receiver 200 shown in FIG. 2 may be installed in a digital broadcasting receiving system using an 8VSB transmission method. Alternatively, the RF receiver 200 may be installed in a system of receiving a multichannel RF signal transmitted via a single carrier. The RF receiver 200 may be installed in a tuner of an RF receiving system or other devices measuring and improving a signal-to-noise ratio (SNR) of a received signal (input signal).

Referring to FIG. 2, the RF receiver 200 includes an AGC amplifier 210 and an SNR adjuster 230.

The AGC amplifier 210 includes an attenuator 211 and an amplifier 213.

The attenuator 211 is controlled by the SNR adjuster 230 to attenuate a magnitude of the received signal. The received signal includes a desired signal component combined with a number of undesired signals. However, both the desired signal component and undesired signals are attenuated by the attenuator 211.

The amplifier 213 amplifies an output of the attenuator 211 to a desired magnitude.

In an intermodulation signal that is a noise of a signal, a 3^{rd} intermodulation distortion (IMD) is the greatest problem. The intermodulation signal is generated when a signal passes through a non-linear circuit of the amplifier 213 and/or between the amplifier 213 and the SNR adjuster 230.

However, if the input signal passes through the non-linear circuit after the attenuation of the attenuator 211, an output having the 3^{rd} IMD is three times more decreased than a desired output signal. Thus, a total SNR is improved.

The SNR adjuster 230 includes a first band pass filter (BPF) 231, a second BPF 233, a first AGC detector 235, a second AGC detector 237, and a solver 239.

The SNR adjuster 230 measures an SNR of a received channel and controls the attenuator 211 to attenuate a magnitude of input signals and obtain a desired SNR. The SNR adjuster 230 measures a power of an inband instead of accurate noise of the inband to measure a magnitude of noise including the 3rd IMD inserted into the inband.

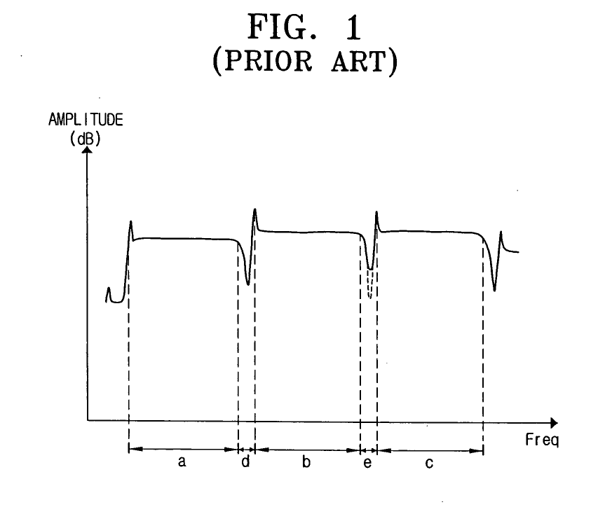

The first BPF 231 separates only a signal of a desired inband from a received multichannel signal. The first BPF 231 may be a surface acoustic wave (SAW) filter. The channels a, b, and c shown in FIG. 1 correspond to inbands from which an inband signal of a desired channel is separated.

The second BPF 233 separates only an inter-band signal corresponding to noise from the received multichannel signal. The second BPF 233 may be the SAW filter. The intervals d and e shown in FIG. 1 correspond to inter-bands. If the first BPF 231 filters the inband b, the second BPF 233 filters the inter-band e.

The first AGC detector 235 measures a power of a signal of the inband separated by the first BPF 231.

The second AGC detector 237 measures a power of noise from the inter-band signal separated by the second BPF 233.

The solver 239 obtains a ratio of the power of the noise of the inter-band measured by the second AGC detector 237 to the power of the inband signal measured by the first AGC detector 235 to obtain an SNR of the inband so as to control an attenuation degree of the attenuator 211.

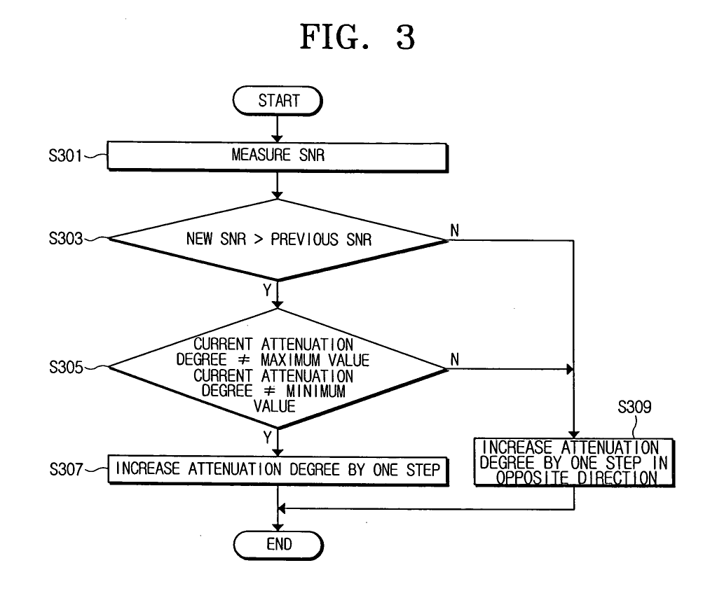

FIG. 3 is a flowchart illustrating an operation of the solver 239 of FIG. 2.

In operation S301, the solver 239 measures an SNR. In operation S303, the solver 239 compares the measured SNR with a previous SNR.

If the solver 239 determines in operation S303 that the measured SNR is higher than the previous SNR, in operation 305, the solver 239 determines whether a current attenuation degree of the attenuator 211 is different from a maximum or minimum attenuation degree of the attenuator 211.

If the solver 239 determines in operation S305 that the current attenuation degree is different from the maximum or minimum attenuation degree, in operation S307, the solver 239 controls the attenuator 211 to increase the current attenuation degree by one step. That is, if the current attenuation degree is between the maximum value and the minimum value, the attenuation degree is increased by a certain value (one step).

If the solver 239 determines in operation S303 that the measured SNR is lower than the previous SNR or determines in operation S305 that the current attenuation degree reaches the maximum or minimum attenuation degree, in operation S309, the solver 239 controls the attenuator 211 to increase the current attenuation degree by one step in an opposite direction to a current attenuation direction of the attenuator 211. That is, if the current attenuation degree is the same as or not the maximum value and the minimum value, the attenuation degree is changed by a certain value (one step) in the opposite direction. In other words, if the attenuator 211 increases the attenuation degree by the unit of one step, the solver 239 controls the attenuator 211 to lower the attenuation degree by the unit of one step. If the attenuator 211 lowers the attenuation degree by the unit of one step, the solver 239 controls the attenuator 211 to increase the attenuation degree by the unit of one step.

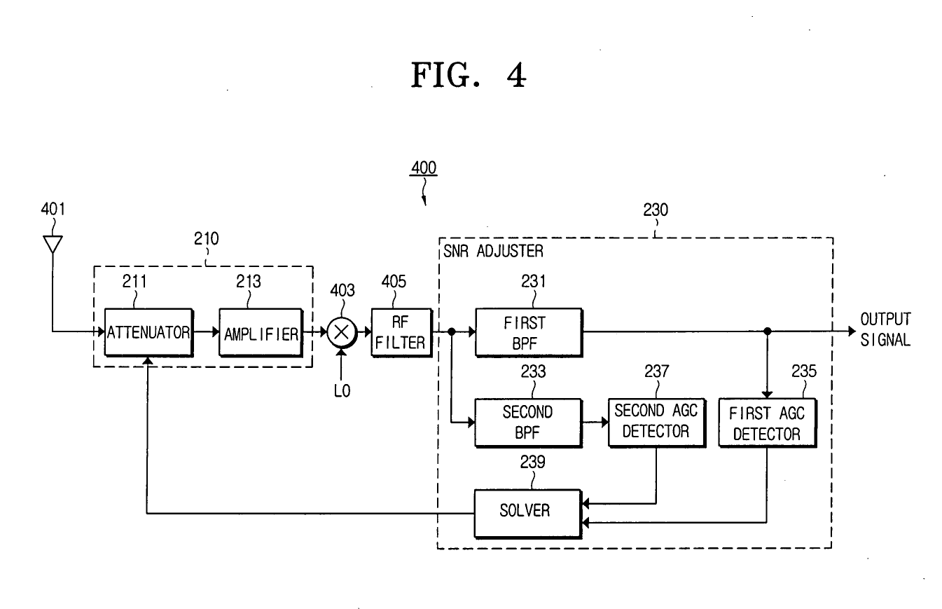

FIG. 4 is a block diagram of an RF receiver 400 using an AGC according to another embodiment of the present general inventive concept.

The RF receiver 400 may be used in a tuner or the like to select a signal of a desired channel from a multichannel RF signal. The RF receiver 400 will be described with reference to a digital TV broadcasting receiving system using an 8VSB modulation method according to the Advanced Television System Committee (ATSC) standards.

The ATSC standards were adopted by U.S. Federal Communication Commission (FCC) in Dec. 24, 1996 and mainly relate to compression and transmission of video and audio streams. According to the ATSC standards, image signals are compressed with MPEG2, acoustic and voice signals are compressed with AC-3, and such signals are transmitted using a VSB transmission technique. In a VSB modulation method, a broadcasting signal is transmitted with a single carrier. A frequency spectrum of a digital broadcasting signal using an 8 VSB transmission method is represented by a waveform shown in FIG. 1.

The RF receiver 400 includes an antenna 401, an attenuator 211, an amplifier 213, a mixer 403, an RF filter 405, and an SNR adjuster 230. The SNR adjuster 230 includes a first BPF 231, a second BPF 233, a first AGC detector 235, a second AGC detector 237, and a solver 239.

The mixer 403 that is a non-linear device and the RF filter 405 are connected between the AGC amplifier 210 and the SNR adjuster 230. The same reference numerals of the RF receiver 400 as those of the RF receiver 200 denote like elements and thus will not be described herein.

If a digital TV broadcasting signal is received via the antenna 401, the attenuator 211 and the amplifier 213 attenuates and amplifies the digital TV broadcasting signal through a feedback of the solver 239. A frequency of the digital TV broadcasting signal of which gain has been adjusted, is changed by the mixer 403 which has received a frequency of a local oscillator (LO), and then the digital TV broadcasting signal is filtered by the RF filter 405 to be a signal in an intermediate frequency bandwidth.

The digital TV broadcasting signal having passed through the amplifier 213 passes through the mixer 403 and the RF filter 405 so as to produce an intermodulation signal due to a signal of adjacent channels and nonlinearity of the amplifier 213 and the mixer 403. A portion of the band intermodulation signal may be removed by the RF filter 405 and first BPF 231. However, the 3^{rd} IMD in the inband is not removed. As a result, an SNR of the received signal may be deteriorated.

However, the solver 239 measures an SNR via the first and second BPFs 231 and 233 and the first and second AGC detectors 235 and 237 and controls the attenuator 211 to attenuate the received signal based on the measured SNR. That is, all portions of the received signal including the inband signal and the inter-band signal can be attenuated according to the measured SNR. As a result, the magnitude of the noise caused by intermodulation in the inband by the amplifier 213, the mixer 403, and the like are considerably reduced, and the SNR improves.

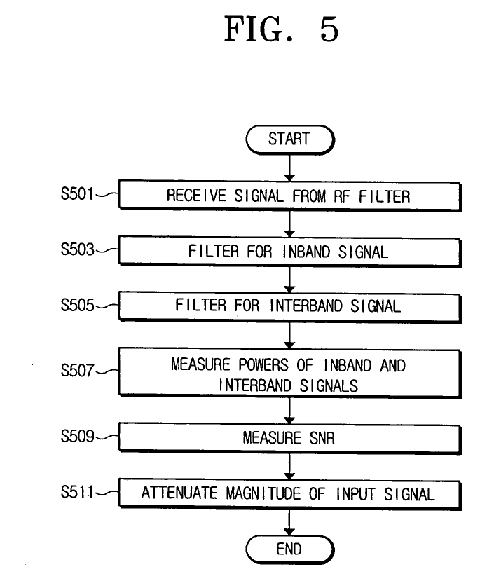

FIG. 5 is a flowchart illustrating an operation of an RF receiver using an AGC according to an embodiment of the present invention. The operation of the RF receiver 200 has been described with reference to FIGS. 1 through 4. However, the RF receiver 400 shown in FIG. 4 will be exemplarily explained with reference to FIG. 5.

The solver 239 controls the attenuator 211 to attenuate a digital broadcasting signal received via the antenna 401 to a current attenuation degree. The amplifier 213 amplifies the digital broadcasting signal to have the same magnitude as a desired inband signal. In operation S501, the mixer 403 and the RF filter 405 changes the amplified digital broadcasting signal into a broadcasting signal in an intermediate frequency bandwidth.

In operation S503, the first BPF 231 filters the digital broadcasting signal to obtain an inband signal of a desired channel.

In operation S505, the second BPF 233 filters the digital broadcasting signal to obtain noise that is representative of an inter-band signal adjacent to the desired channel.

In operation S507, the first and second AGC detectors 235 and 237 measure a power of the inband signal obtained by the first BPF 231 and a power of the noise obtained by the second BPF 233, respectively.

In operation S509, the solver 239 measures an SNR using the powers measured by the first and second AGC detectors 235 and 237. In operation S511, the solver 239 compares the measured SNR with a previous SNR to control an attenuation degree of the attenuator 211 so as to attenuate the received digital broadcasting signal.

The operation of an RF receiver using an AGC can be performed according to the above-described process.

As described above, in an RF receiver using an AGC, and an RF receiving method according to an embodiment of the present general inventive concept, the influence of noise of an intermodulation signal produced by a non-linear device that may be installed in the RF receiver on an RF signal including a multichannel, can be reduced. Also, an SNR of a received signal can be improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A radio frequency (RF) receiver comprising:
an attenuator to receive and attenuate a radio frequency signal having one or more inband signals of at least one channel and an inter-band signal between the inband signals according to a predetermined attenuation degree;
an amplifier to amplify a signal output from the attenuator; and
a signal-to-noise ratio adjuster to measure a signal-to-noise ratio of the inband signal of a desired channel of a signal output from the amplifier and to control the attenuation degree of the attenuator so that the measured signal-to-noise ratio is maintained higher than a previous signal-to-noise ratio.

2. The radio frequency receiver of claim 1, wherein if the measured signal-to-noise ratio is higher than the previous signal-to-noise ratio, the signal-to-noise ratio adjuster increases or decreases the attenuation degree of the attenuator in an identical direction to a previous increase or decrease direction.

3. The radio frequency receiver of claim 1, wherein if the measured signal-to-noise ratio is lower than the previous signal-to-noise ratio, the signal-to-noise ratio adjuster increases or decreases the attenuation degree of the attenuator in an opposite direction to a previous increase or decrease direction.

4. The radio frequency receiver of claim 1, wherein if the measured signal-to-noise ratio is higher than the previous signal-to-noise ratio, and if the attenuation degree of the attenuator is equal to one of maximum and minimum values, the signal-to-noise ratio adjuster increases or decreases the attenuation degree of the attenuator in tan opposite direction to a previous increase or decrease direction.

5. The radio frequency receiver of claim 1, wherein the signal-to-noise ratio adjuster comprises:
a first band pass filter separating an inband signal of a desired channel of the received signal;
a second band pass filter to separate an inter-band signal of the received signal adjacent to the inband signal of the desired channel;
a first auto gain control detector to measure a power of the inband signal separated by the first band pass filter;
a second auto gain control detector to measure a power of the inter-band signal separated by the second band pass filter; and
a solver to measure a signal-to-noise ratio of the inband signal using the power measured by the first auto gain control detector as a power of a signal and the power measured by the second auto gain control detector as a power of noise and to control the attenuation degree of the attenuator.

6. The radio frequency receiver of claim 5, wherein the first and second band pass filters are surface acoustic wave filters.

7. The radio frequency receiver of claim 1, wherein the radio frequency signal is a digital television broadcasting signal using an 8 vestigial side band method.

8. The radio frequency receiver of claim 7, further comprising:
a mixer installed between the amplifier and the signal-to-noise ratio adjuster to receive a signal of a predetermined local oscillator so as to transform a frequency of the received digital broadcasting signal into a frequency bandwidth of a channel to be selected; and
a radio frequency filter to filter an output of the mixer except the broadcasting signal and to transmit the filtered signal to the signal-to-noise ratio adjuster.

9. A tuner to select a desired broadcasting signal of a digital television broadcasting signal using an 8 vestigial side band method, comprising:
a radio frequency receiver comprising,
an attenuator to receive and attenuate a radio frequency signal having one or more inband signals of at least one channel and an inter-band signal between the inband signals according to a predetermined attenuation degree,
an amplifier to amplify a signal output from the attenuator, and
a signal-to-noise ratio adjuster measure a signal-to-noise ratio of the inband signal of a desired channel of a signal output from the amplifier and to control the attenuation degree of the attenuator so that the measured signal-to-noise ratio is maintained higher than a previous signal-to-noise ratio.

10. A radio frequency receiving method comprising:
receiving and attenuating a radio frequency signal having one or more inband signals of at least one channel and an inter-band signal between the inband signals according to a predetermined attenuation degree;
amplifying an output signal; and
measuring a signal-to-noise ratio of the inband signal of a desired channel of the output signal and controlling the attenuation degree so that the measured signal-to-noise ratio is maintained higher than a previous signal-to-noise ratio.

11. The radio frequency receiving method of claim 10, wherein if the measured signal-to-noise ratio is higher than the previous signal-to-noise ratio, the attenuation degree is increased or decreased in an identical direction to a previous increase or decrease direction.

12. The radio frequency receiving method of claim 10, wherein if the measured signal-to-noise ratio is lower than the previous signal-to-noise ratio, the attenuation degree is increased or decreased in an opposite direction to a previous increase or decrease direction.

13. The radio frequency receiving method of claim 10, wherein if the measured signal-to-noise ratio is higher than the previous signal-to-noise ratio, and the attenuation degree is equal to one of maximum and minimum values, the attenuation degree is increased or decreased in an opposite direction to a previous increase or decrease direction.

14. The radio frequency receiving method of claim 10, wherein controlling the attenuation degree comprises:
filtering to separate the inband signal of a desired channel of the received signal and measuring a power of the separated inband signal;
filtering to separate the inter-band signal of the received signal adjacent to the inband signal of the desired channel and measuring a power of the separated inter-band signal; and
measuring the signal-to-noise ratio of the inband signal using the power of the inband signal as a power of a signal and the power of the inter-band signal as a power of noise and controlling the attenuation degree according to the signal-to-noise ratio.

15. The radio frequency receiving method of claim 14, wherein the powers of the inband and inter-band signals are measured using surface acoustic wave filters.

16. The radio frequency receiving method of claim 10, wherein the radio frequency signal is a digital television broadcasting signal using an 8 vestigial side band method.

17. The radio frequency receiving method of claim 10, further comprising:
receiving a signal of a predetermined local oscillator so as to transform a frequency of the received digital broadcasting signal into a frequency bandwidth of a channel to be selected; and
filtering an output signal of the frequency bandwidth except the broadcasting signal and transmitting the filtered signal.
